(19) United States
(12) Patent Application Publication
(10) Pub. No.: US 2004/0119684 A1
(43) Pub. Date: Jun. 24, 2004

(54) System and method for navigating information

(75) Inventors: Maribeth Joy Back, San Francisco, CA (US); Roy Want, Los Altos, CA (US)

Correspondence Address: Gunnar G. Leinberg, Esq., Nixon Peabody LLP, Clinton Square, P.O. Box 31051, Rochester, NY, 14603-1051, US

(73) Assignee: Xerox Corporation

(21) Appl. No.: 10/324,620

(22) Filed: Dec. 18, 2002

(51) Int. Cl. G09G 5/00

(52) U.S. Cl. 345/156

(57) ABSTRACT

System and method for navigating information. The system includes an information presentation device having an output portion (e.g., display device or audio device) and one or more motion sensors. The method includes the motion sensors monitoring for at least one movement of the information display device while the device dynamically presents information at its output portion. Upon the sensors detecting movement of the device, the device adjusts the manner in which the information is dynamically presented to enable operators of the device to easily navigate to an appropriate location of the information and adjust the manner in which it is dynamically presented (e.g., the rate of the dynamic presentation).

### FIELD

This invention relates generally to a system and method for information presentation and, more particularly, to a system and method for navigating dynamic text displayed on a device in response to movement of the device.

### BACKGROUND

Displays on hand-held and other small portable devices have very limited screen space. As a result, they are not well-suited for the display of information such as text and graphics using conventional display techniques. One solution to this problem of displaying information has been to display the information using dynamic presentation techniques such as rapid serial visual presentation (“RSVP”). RSVP is one of several dynamic display techniques and involves sequentially presenting portions of a document (e.g., words) one at a time, at a selected rate and at a fixed location on a display.

Operators of hand-held and other small portable display devices have benefited greatly from these techniques since they permit ample amounts of information to be delivered at a rapid rate to the operators of the devices despite limited screen space. Unfortunately, navigation within dynamically displayed text using the above-mentioned techniques has been difficult. Since the dynamic display techniques can involve rapidly displaying information in unusual formats and at varying display rates, it becomes increasingly necessary for operators to quickly make subtle adjustments for changing the rate text is displayed, displaying different sections of displayed text and re-displaying portions of text, for example.

### SUMMARY

A device for navigating dynamically presented information in accordance with embodiments of the present invention includes a motion sensor system, an information output system and a processing system. The motion sensor system monitors for at least one movement of the device, the information output system dynamically presents at least one portion of information at an output portion of the device, and the processing system adjusts the dynamic presentation based upon the monitored movement.

A method and a program storage device readable by a machine and tangibly embodying a program of instructions executable by the machine for navigating dynamically presented information in accordance with embodiments of the present invention includes monitoring for at least one movement of an information presentation device, dynamically presenting at least one portion of information at an output portion of the information presentation device, and adjusting the dynamic presentation based upon the monitored movement.

The present invention provides a system and method for easily and efficiently navigating through information being presented on a device, rapidly and in a dynamic manner. The operator of the present invention can easily adjust the dynamic presentation of the information with simple movements of the device. As a result, the operator can easily navigate to an appropriate location of the information and adjust the manner in which it is presented (e.g., the rate of the dynamic presentation).

### BRIEF DESCRIPTION OF THE DRAWINGS

FIG. 1 is a perspective view of a device for navigating dynamic text in accordance with embodiments of the present invention;

FIG. 2 is a block diagram of a device for navigating dynamic text in accordance with embodiments of the present invention;

FIG. 3 is a flow chart of a process for navigating dynamic text; and

FIG. 4 is a flow chart of a process for determining user input based upon detected movement of the device.

### DETAILED DESCRIPTION

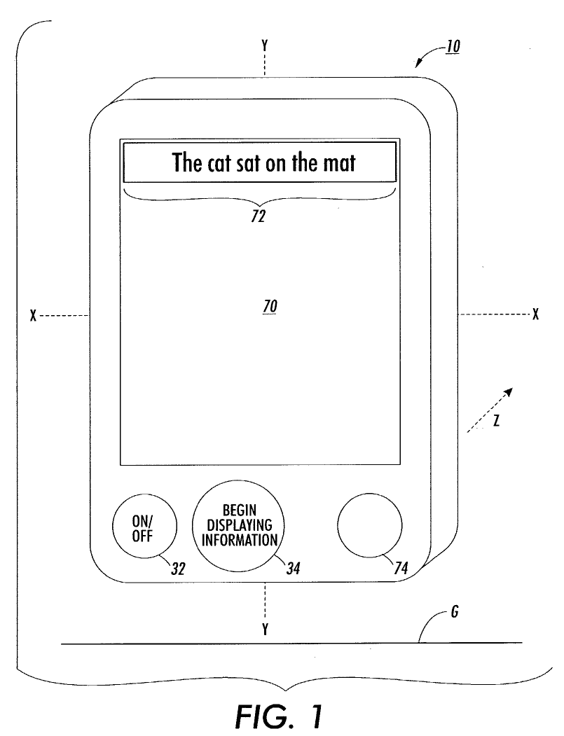

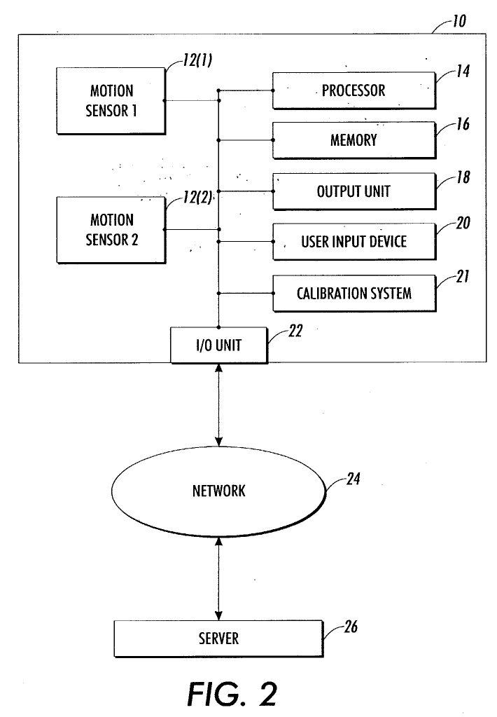

A device 10 for navigating dynamic information, such as text in accordance with embodiments of the present invention is shown in FIGS. 1 and 2. The device 10 includes motion sensors 12(1)-12(2), a central processing unit (“CPU”) or processor 14, memory 16, an output unit 18 and an optional calibration system 21. A method for navigating dynamic text in accordance with embodiments of the present invention includes monitoring for at least one movement of the device 10, dynamically presenting portions of information at the output unit 18 and adjusting the dynamic presentation based upon the monitored movement. The present invention provides a method and system for easily and efficiently navigating through information being presented on a device 10 rapidly and in a dynamic manner. The operator of the present invention can easily adjust the dynamic presentation of the information with simple movements of the device 10. As a result, the operator can easily re-display portions of the information, navigate to a desired location of the information and adjust the manner in which it is dynamically presented (e.g., the rate of the dynamic presentation).

Referring more specifically to FIGS. 1-2, in embodiments of the present invention device 10 comprises a personal digital assistant modified and configured as described further herein. Device 10 may, however, comprise any type of stationary or portable machine such as a personal or laptop computer, a hand-held computer, a portable document reader or an electronic book, which is configured to operate with the components associated with device 10 to perform methods in accordance with the present invention as described and illustrated herein.

Referring to FIG. 2, the components of device 10 will now be described. In embodiments of the present invention, device 10 includes motion sensors 12(1)-12(2), processor 14, memory 16, output unit 18, user input device 20 and an input/output (“I/O”) unit 22, which are coupled together by one or more buses, although device 10 may include other components and systems. Motion sensors 12(1)-12(2) each comprise a tilt motion sensor, such as an iMEMS® Accelerometer Model No. ADXL202 manufactured by Analog Devices, Inc., and described in “ADXL202/ADXL210— Low Cost±2 g/+10 g Dual Axis iMEMS® Accelerometers with Digital Output (Datasheet, Rev. B-4/99),” Analog Devices, Inc., One Technology Way, PO Box 9106, Norwood, Mass., USA, 1999, which is hereby incorporated by reference in its entirety, although sensors 12(1)-12(2) may each comprise other types of motion sensors made by other manufacturers.

In embodiments of the present invention, motion sensors 12(1)-12(2) each generate and provide duty cycle modulated (“DCM”) digital signals to processor 14 that are representative of the orientation of the device 10 with respect to a fixed point of reference such as the ground G along two axis (e.g., X and Y axis), although the sensors 12(1)-12(2) may be configured to provide processor 14 with other types of reference signals, such as other types of analog or digital signals. In particular, sensors 12(1)-12(2) measure positive and negative accelerations to a maximum level of about ±2 g, to quantify static acceleration forces such as gravity for detecting when and the extent in which the sensors 12(1)-12(2), and hence the device 10 they are arranged in, is tilted with respect to a frame of reference. The DCM digital signal output of sensors 12(1)-12(2) has duty cycles (i.e., the ratio of pulse width to a time period) that are proportional to the acceleration in each of the sensitive axis of sensors 12(1)-12(2). Moreover, each sensor 12(1)-12(2) is capable of detecting acceleration in two axis (i.e., sensitive axis) such as the X and Y axis.

In embodiments of the present invention, two sensors 12(1)-12(2) are used in the device 10, although a lesser or greater number of sensors 12(1)-12(2) may be used. The sensors 12(1)-12(2) are arranged within device 10 and may be oriented perpendicular with respect to each other, although the sensors 12(1)-12(2) may be arranged within device 10 in a variety of orientations, such as parallel with respect to each other. Thus, upon sensor 12(1) detecting a maximum change in output per angular degree between the X and Y axis, sensor 12(2) detects a minimum change. Conversely, upon sensor 12(2) detecting a maximum change in output per degree, sensor 12(1) detects a minimum change. This way, sensors 12(1)-12(2) may detect movement (e.g., tilting) of device 10 in a substantially 360 degree radius in the X, Y and Z axis.

Processor 14 comprises any processing unit that is small enough to be arranged within device 10 to enable the device 10 to be light, portable and easily manipulated such as an Intel Strong ARMS processing unit, although other types of processing units may be used. Processor 14 executes at least one program of stored instructions for navigating dynamic text in accordance with embodiments of the present invention in addition to instructions for processing information so it may be presented by output unit 18 through the text display window 72 using a dynamic presentation technique (e.g., RSVP), although other types of programs of stored instructions could be executed.

The instructions may be expressed as executable programs written in a number of computer programming languages, such as BASIC, COBOL, FORTRAN, Pascal, C, C++, C#, Java, Perl, assembly language, machine code language, or any computer code or language that can be understood and executed by the processor 14. Further, processor 14 may include a counter/timer port with associated mechanisms and stored executable instructions for decoding the DCM digital signals received from the sensors 12(1)-12(2) for determining the orientation and extent of the movement of device 10 in the X, Y and Z axis to enable users to navigate the dynamic text presented by output unit 18 as described further herein below.

Memory 16 comprises a hard-disk drive computer-readable medium, although memory 16 may comprise any type of fixed or portable medium accessible by the processor 14, including floppy-disks, compact-disks, digital-video disks, magnetic tape, optical disk, Ferro-electric memory, Ferro-magnetic memory, read-only memory, random access memory, electrically erasable programmable read-only memory, erasable programmable read-only memory, flash memory, static random access memory, dynamic random access memory, charge coupled devices, smart cards, or any other type of computer-readable mediums. Memory 16 stores the instructions and data for performing the present invention for execution by processor 14, although some or all of these instructions and data may be stored elsewhere such as in server 26. Although in embodiments of the present invention the processor 14 and memory 16 are shown in the same physical location, they may be located in different physical locations.

Output unit 18 comprises an LCD display, although output unit 18 may comprise other information output mechanisms such as other types of displays or an audio unit that presents information using an audio speaker 74 arranged in device 10, for example. In embodiments of the present invention, output unit 18 presents information to users on the display screen 70 at text display window 72 using a number of dynamic display techniques such as RSVP, which will be described further herein below.

User input device 20 comprises a controller for accepting user input through one or more user interfaces, such as the ‘on/offbutton’ 32, and the ‘begin displaying information’ button 34, for example, although input device 20 may accept user input through other types of user interfaces including a mouse or keyboard arranged on or coupled to device 10, or a touch pad screen implemented on the display screen 70. The user input device 20 is used to accept commands from an operator of the device 10, such as for powering on or off device 10 or to begin displaying the dynamic text. Further, the input device 20 processes the input commands and sends them to the processor 14 for further processing in accordance with embodiments of the present invention.

Calibration system 21 comprises a module stored in the memory which includes instructions that are executed by the processor 14 to calibrate the sensors 12(1)-12(2) with respect to movements of the device 10 for navigating information.

I/O unit 22 operatively couples device 10 to other systems and machines, such as server 26, via network 24. The I/O unit 22 has one or more ports capable of sending and receiving data to and from the network 24, and hence devices on the network 24, such as the usage metrics system 14. Further, the unit 22 may have one or more ports capable of sending and receiving wireless signals, such as radio or infrared signals, to enable the device 10 to communicate with a wireless network using Bluetooth™ technology, such as network 24 Bluetooth™ network.

Network 24 comprises a public network, such as the Internet, although other types of public and/or private networks 24 may be used, including local area networks (“LANs”), wide area networks (“WANs”), telephone line networks, coaxial cable networks, wireless networks, such as Bluetooth™ networks, and combinations thereof, although the network 24 may comprise a direct connection via a serial or parallel data line to a server 26.

The server 26 comprises a computer server system that includes a processor, memory, mechanisms for reading data stored in the memory, and an I/O unit, which are coupled together by one or more buses, although other coupling techniques may be used. Since devices, such as computer server systems, are well known in the art, the specific elements, their arrangement within the server and basic operation will not be described in detail here. Additionally, the server 26 may comprise other types of systems, such as a scanner device, which can provide information to device 10 through the I/O unit 22 to be presented on device 10, although this information may already be stored in the device 10 at memory 16.

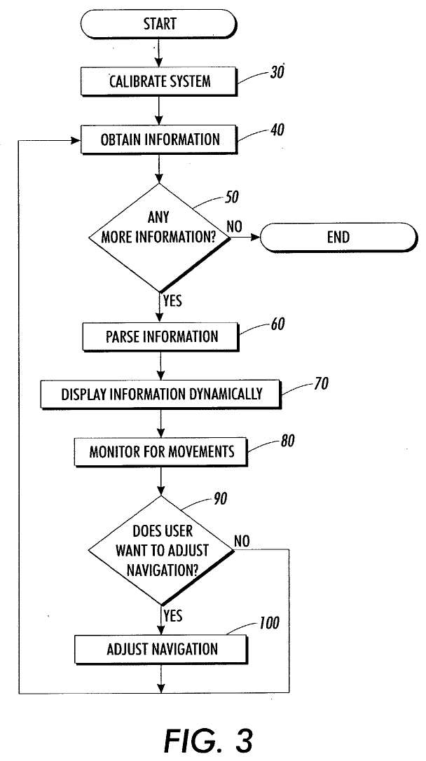

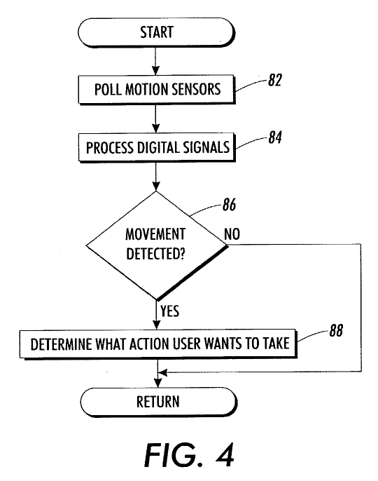

Referring to FIGS. 3-4, the operation of a method for navigating dynamic text in accordance with embodiments of the present invention will now be described with reference to FIGS. 1-2. Beginning at step 30, device 10 is powered-up and causes the calibration system 21 to initiate a calibration routine, if necessary. For example, a user may push down the ‘on/off’ button 32 to initiate the power-up process, for example, which would cause user input device 20 to send processor 14 a signal instructing it to begin displaying the dynamic text. The device 10 may prompt the user using the display screen 70 at text display window 72 to tilt the device 10 in a particular orientation to initiate the calibration routine, although other arrangements are possible. For example, a calibration button (not illustrated) may be provided on device 10 which can be used to initiate the calibration routine.

A user may calibrate the device 10 to enable the processor 14 to more accurately recognize the user's particular range of motion, for example. For instance, some users may interpret a “sideways” motion of device 10 as moving the device 10 back and forth a first distance along an axis, such as the X axis, with respect to the ground G, while other users may interpret the sideways motion as moving the device 10 back and forth along an X axis and a second distance along a Y axis. The device 10 may execute a learning algorithm to program the processor 14 to recognize, adjust and compensate for a user's particular tendencies by guiding the user through a selected set of motions to provide further refinement with respect to the user's tendencies, for example.

Processor 14 may maintain a calibration database in memory 16 that includes initial or default calibration values that may be modified or updated during the operation of device 10 such as a range of motion value for the X, Y and Z axis representing how far the user typically tilts the device 10 in any one direction to achieve a particular motion (e.g., sideways) or an axis offset variable representing what the user typically interprets a particular motion of device 10 to be for the X, Y and Z axis. These values may be obtained by device 10 by leading the user through a series of audio or visual prompts displayed on the display screen 70 requesting the user to tilt the device 10 in various orientations while processor 14 processes the output from sensors 12(1)-12(2) and stores the results in the calibration database.

Next at step 40, the device 10 obtains a portion of the information to be displayed. In particular, a user may push down the ‘begin displaying information’ button 34 to provide processor 14 with a signal to begin displaying the dynamic text. Processor 14 accesses an information database that may be logically organized in memory 16 to retrieve a portion of any content available in the database to be displayed, although the information database may be organized in the memory of server 26 accessed by device 10 through I/O unit 22. Further, any content obtained from the database may be stored in a temporary memory buffer in memory 16 for further processing as described herein in connection with step 60.

In embodiments of the present invention, the information may include any type of content, such as text and graphics obtained from any source such as a book, magazine, e-mail message, Web page content, an article, a news feed or an information feed from a speech to text system. Further, the amount of information included in the portion obtained may depend upon values that are defined in the stored programming executed by the processor 14. Moreover, the values may depend upon the maximum amount of information that device 10 should display in the text display window 72 at each instance to comply with dynamic display technique guidelines (e.g., RSVP).

Next at decision box 50, if device 10 determines at step 40 there is no information available in the information database, the NO branch is followed and the method ends, although steps 40-50 may be repeated until there is information available. But if device 10 determines there is information available in the information database then the YES branch is followed.

Next at step 60, device 10 parses the portion of information obtained in step 40. In particular, processor 14 processes the information by stripping superfluous content associated with the information as originally obtained from its source, such as graphics or formatting, to extract the textual content included in the information, which may then be stored at memory 16 in a temporary buffer or file structured in an XML 1.0 format the specification of which is described in the “Extensible Markup Language (XML) 1.0 (Second Edition)” document, W3C Recommendation, October 2000, which is hereby incorporated by reference in its entirety, although other formats may be used and the information may not need to be parsed for display. Moreover, the display characteristics of the portion of information to be displayed (e.g., text color, text font size, text font type, text background color, etc.) may be specified using the XML tags and identifiers having a default or initial set of display characteristic values.

Next at step 70, device 10 displays the parsed information on the display screen 70 at the text display window 72, although the parsed information may be presented as audio in the form of spoken words through the speaker device 74. In particular, processor 14 may execute a Java 2.0 application, the specification of which is hereby incorporated by reference in its entirety, and stored in the memory 16 or otherwise accessible to device 10 through I/O unit 22. The Java 2.0 application is configured to accept the parsed information stored in the XML format as input. Processor 14, by executing the Java 2.0 application in this context, is able to interpret the XML formatted parsed information to cause the text to be displayed in the manner specified by the XML instructions, which is displayed in text display window 72 on the display screen 70 using an RSVP display technique that will be described further herein below. For further general information with respect to the Java programming language, see “The Java™ Language Specification Second Edition,” Gosling et al., Sun Microsystems, Inc. 2000, which is also hereby incorporated by reference in its entirety.

The processor 14 presents the textual information in the text window 72 in the format specified by the XML instructions. Moreover, device 10 is programmed to begin displaying the parsed information using the default set of display characteristic values specified by the XML formatting instructions. For instance, the parsed information (i.e., dynamic text) may be initially displayed at a rate of 1000 words per minute, having a low contrast level and a 12 point font size. In embodiments of the present invention, the processor 14 executes instructions to cause the textual information to be displayed using a rapid serial visual presentation (“RSVP”) technique, which involves displaying portions of information such as words, sequentially, one at a time, at a fixed location (e.g., text display window 72) and at a selected rate, although device 10 may display information using other dynamic presentation techniques, such as several words at one time or scrolling words. Further, the device 10 may display one or more additional control windows (not illustrated) to provide users of device 10 with visual indications of changes with respect to the manner (e.g., text display rate, text font size, etc.) in which the information is displayed.

Next at step 80, device 10 determines whether the user is generating any input by moving or tilting device 10 to change its orientation. In particular, the device 10 is able to detect whether the user is changing the orientation of the device 10 with respect to the X, Y and Z axis. Moreover, device 10 determines what type of navigation input the user is attempting to express for navigating through the dynamic text being displayed in the text window 72 based upon the stored programming it is executing as explained further herein.

Referring to FIG. 4, a process for determining whether user input is being generated will now be described in further detail. At step 82, the processor 14 executes a polling routine to monitor for any movement of device 10 with respect to the X, Y and Z axis by interrogating its associated counter/timer port at predetermined time increments (e.g., every ten milliseconds) to determine whether it has received any DCM digital signals from the sensors 12(1)-12(2) while steps 30-100 are executed as described herein, although the sensors 12(1)-12(2) maybe programmed to set a flag, send an interrupt or otherwise provide the processor with an indication that new data has been or is being generated by the sensors 12(1)-12(2) with respect to the orientation of device 10.

Next at step 84, processor 14 processes any available digital signals to determine the extent of movement of device 10 detected by sensors 12(1)-12(2). As sensors 12(1)-12(2) detect movement, they may associate an identifier with the digital signals to indicate which one of sensors 12(1)-12(2) the signals are associated with, although processor 14 may also decipher which digital signals are associated with which one of sensors 12(1)-12(2) by virtue of the particular output leads of sensors 12(1)-12(2) the digital signals are being sent from.

Next at decision box 86, if at step 84 processor 14 receives digital signals indicating that the orientation of device 10 has changed then the YES branch is followed.

Next at step 88, device 10 determines what action a user desires with respect to navigating the dynamic text being displayed at the text window 72 based upon the DCM digital signals sent to the processor 14 from sensors 12(1)-12(2) indicating the new orientation of device 10 and the extent of movement. In embodiments of the present invention, an action database logically organized in memory 16 may store the dynamic text navigation actions device 10 may take depending upon the particular movements of device 10 as detected by sensors 12(1)-12(2).

For instance, the action database may store an association between the movement of device 10 in a first orientation (e.g., sideways along the X axis) and displaying a preceding or proceeding set of the information obtained in step 40, such as the last displayed word on text display window 72 (i.e., the preceding set) or a next word stored in the temporary memory buffer awaiting to be displayed on the text window 72 (i.e., the proceeding set). Likewise, the action database may store an association between movement of device 10 in a second orientation (e.g., downward towards the ground G) and clearing the text window 72. Still further, the action database may store an association between movement of device 10 in a third orientation (e.g., a rapid movement of device 10 along the Z axis) and changing the rate at which the text is dynamically displayed, which may be changed in units of words per minute, for example. Additionally, processor 14 may be programmed to associate navigation actions with particular acceleration values of the device 10 in a particular direction (e.g., the first orientation), for example.

Referring back to decision box 86, if processor 14 does not detect movement of device 10 then the NO branch is followed.

Referring back to FIG. 3 and now to decision box 90, if device 10 at step 80 determines the user desires adjusting the navigation through the dynamic text being displayed at the text window 72 (e.g., clear the text window 72 or re-display the last displayed word), the YES branch is followed.

Next at step 100, device 10 adjusts the display of the dynamic text at the text window 72 according to the detected movement of device 10. By way of example only, device 10 may have a default position with respect to one or more fixed axis along the X, Y and Z axis, which may be perpendicular to the ground G. This default position may be at a particular angle, for example, with respect to the Z axis and the ground G or the X axis. Upon the device 10 being moved away from its default orientation, the sensors 12(1)-12(2) may generate digital signals that processor 14 may process to determine the new orientation of the device 10. Thus, for example, processor 14 may be programmed to determine the user would like to change the display rate of the text being displayed in the text display window 72 by increasing it when it detects the device 10 being moved upwards along the Y axis away from the ground G, although other orientations of device 10 could instead be associated with this particular navigation action.

Further, the processor 14 may be configured to begin gradually increasing the display rate of the dynamic text in the text display window 72 a predetermined amount of time after detecting the user's intention, such as one second after. The processor 14 may increase the text display rate by incremental display rate values such as by a factor of about 100 words per minute every three seconds, although other incremental values and predetermined time values may be used. Processor 14 may then increase the dynamic text display rate until a maximum display rate value has been reached (e.g., about 4,000 words per minute) or device 10 detects the user's desire to halt increasing the text display rate by detecting additional user input by the user. In particular, the processor 14 may be programmed to interpret subsequent movements in a particular orientation (e.g., sideways) as expressing a user's desire to halt increasing the rate of display while steps 82-88 are executed as described above.

In embodiments of the present invention, steps 40-100 are performed continuously. Thus, while step 100 is being performed as described herein, device 10 may perform steps 40-90. In particular, at step 80, device 10 determines whether the user has generated additional input depending upon the detection of movement of the device 10. Moreover, device 10 may be programmed to interpret user input (i.e., movement of device 10) as detected by the sensors 12(1)-12(2) in the context of the user's prior input, although each dynamic text navigation action may be associated with particular orientations of device 10 regardless of any prior input.

While particular embodiments have been described, alternatives, modifications, variations, improvements, and substantial equivalents that are or may be presently unforeseen may arise to applicants or others skilled in the art. Accordingly, the appended claims as filed, and as they may be amended, are intended to embrace all such alternatives, modifications, variations, improvements, and substantial equivalents. Further, the recited order of processing elements or sequences, or the use of numbers, letters, or other designations therefor, is not intended to limit the claimed processes to any order except as may be specified in the claims.

What is claimed is:

1. A method comprising:
monitoring for at least one movement of an information presentation device;
dynamically presenting at least one portion of information at an output portion of the information presentation device; and
adjusting the dynamic presentation based upon the monitored movement.

2. The method as set forth in claim 1 wherein monitoring the movements further comprises sensing changes in the acceleration of the information presentation device along at least one axis.

3. The method as set forth in claim 1 wherein the dynamic presentation further comprises displaying the at least one portion of information on a display device associated with the output portion using a rapid serial visual presentation technique.

4. The method as set forth in claim 1 wherein the adjusting further comprises dynamically presenting a preceding segment or a proceeding segment of the at least one portion of the information based upon the monitored movement in a first direction.

5. The method as set forth in claim 4 wherein the adjusting further comprises ceasing to dynamically present the at least one portion of information based upon the monitored movement in a second direction.

6. The method as set forth in claim 5 wherein the adjusting further comprises changing a rate of the dynamic presentation based upon the monitored movement in a third direction.

7. The method as set forth in claim 1 wherein the adjusting further comprises changing the dynamic presentation based upon at least one detected orientation of the information presentation device with respect to a fixed point of reference.

8. The method as set forth in claim 1 wherein each of the portions of information comprise at least one of a word having at least one textual symbol and a spoken word.

9. The method as set forth in claim 1 further comprising calibrating the information presentation device.

10. A computer readable medium having stored thereon instructions, which when executed by at least one processor, causes the processor to perform:
monitoring for at least one movement of an information presentation device;
dynamically presenting at least one portion of information at an output portion of the information presentation device; and
adjusting the dynamic presentation based upon the monitored movement.

11. The medium as set forth in claim 10 wherein monitoring the movements further comprises sensing changes in the acceleration of the information presentation device along at least one axis.

12. The medium as set forth in claim 10 wherein the dynamic presentation further comprises displaying the at least one portion of information on a display device associated with the output portion using a rapid serial visual presentation technique.

13. The medium as set forth in claim 10 wherein the adjusting further comprises dynamically presenting a preceding segment or a proceeding segment of the at least one portion of the information based upon the monitored movement in a first direction.

14. The medium as set forth in claim 13 wherein the adjusting further comprises ceasing to dynamically present the at least one portion of information based upon the monitored movement in a second direction.

15. The medium as set forth in claim 14 wherein the adjusting further comprises changing a rate of the dynamic presentation based upon the monitored movement in a third direction.

16. The medium as set forth in claim 10 wherein the adjusting further comprises changing the dynamic presentation based upon at least one detected orientation of the information presentation device with respect to a fixed point of reference.

17. The medium as set forth in claim 10 wherein each of the portions of information comprise at least one of a word having at least one textual symbol and a spoken word.

18. The medium as set forth in claim 10 further comprising calibrating the information presentation device.

19. A system comprising:
a sensor system that monitors for at least one movement of an information presentation device;
an information output system that dynamically presents at least one portion of information at an output portion of the information presentation device; and
a processing system that adjusts the dynamic presentation based upon the monitored movement.

20. The system as set forth in claim 19 wherein the sensor system further comprises at least one motion sensor that monitors the movements by sensing changes in the acceleration of the information presentation device along at least one axis.

21. The system as set forth in claim 19 wherein the information output system further comprises a display device associated with the output portion that displays the information using a rapid serial visual presentation technique.

22. The system as set forth in claim 19 wherein the processing system presents a preceding segment or a proceeding segment of the at least one portion of the information based upon the monitored movement in a first direction.

23. The system as set forth in claim 22 wherein the processing system ceases dynamically presenting the at least one portion of information based upon the monitored movement in a second direction.

24. The system as set forth in claim 23 wherein the processing system changes a rate of the dynamic presentation based upon the monitored movement in a third direction.

25. The system as set forth in claim 19 wherein the processing system changes the dynamic presentation based upon at least one detected orientation of the information presentation device with respect to a fixed point of reference.

26. The system as set forth in claim 19 wherein each of the portions of information comprise at least one of a word having at least one textual symbol and a spoken word.

27. The system as set forth in claim 19 further comprising a calibration system that calibrates the information presentation device.
